(19) United States
(12) Patent Application Publication
(10) Pub. No.: US 2011/0166743 A1
(43) Pub. Date: Jul. 7, 2011

(54) Vehicular information storage apparatus and vehicle diagnosis system

(75) Inventor: Yuji Sato, Kariya-city (JP)

(73) Assignee: DENSO CORPORATION, Kariya-city (JP)

(21) Appl. No.: 12/926,755

(22) Filed: Dec. 8, 2010

(30) Foreign Application Priority Data
Jan. 7, 2010 (JP) 2010-2043
Sep. 10, 2010 (JP) 2010-203087

(51) Int. Cl. G06F 7/00

(52) U.S. Cl. 701/33; 701/35

(57) ABSTRACT

In cases that one of conditions registered in a record data classification table is satisfied, the accordance with a condition for recording in a nonvolatile record data database is determined. A cycle record data element according with a record content corresponding to the condition determined to be satisfied is retrieved from cycle record data elements recorded in a cycle record data database. Retrieved cycle record data element is recorded in the nonvolatile record data database as nonvolatile record data. Those conditions are satisfied, respectively, as follows: (i) in cases that a vehicular system starts; (ii) in cases that a system parameter is changed; (iii) in cases that a specified time elapses after departure; (iv) in cases that it comes to the time before arrival; (v) in cases that a subject vehicle is located in a user defect detection area; and (vi) in cases that an external remote manipulation is executed.

### CROSS REFERENCE TO RELATED APPLICATION

The present application is based on and incorporates herein by reference Japanese Patent Applications No. 2010-2043 filed on Jan. 7, 2010, and No. 2010-203087 filed on Sep. 10, 2010.

### FIELD OF THE INVENTION

The present invention relates to a technology to record vehicle state information that contributes to a cause ascertainment of a defect which has a low occurrence frequency or a low detection frequency while having a difficulty in reproduction and identification of cause, the technology further identifying a cause of a defect based on the recorded information.

### BACKGROUND OF THE INVENTION

[Patent document 1] JP-2009-145117 A (WO 2009-075338)
[Patent document 2] JP-2005-146905 A

There is conventionally known a process that monitors vehicle information on vehicle state to detect a vehicle defect based on the monitored vehicle information, and records the monitored vehicle information when the defect is detected in a nonvolatile storage media or the like. Further, the information thus stored in the nonvolatile storage media can be used for verification of the defect cause. Such verification of the defect cause is called a self-diagnosis etc.

For example, Patent document 1 discloses a technology that acquires state information of a subject vehicle, identifies an occurrence time point of a defect in the vehicle based on the acquired information, specifies the information, which should be used for verification of the defect cause out of the acquired information, on the basis of the identified occurrence time point of the defect, and stores the specified information in a predetermined storage media.

Patent document 2 discloses a technology in which when each vehicle runs a “specified place” such as a slope, pre-diagnosis information for each vehicle running the specified place is acquired; the acquired pre-diagnosis information is accumulated; the accumulated pre-diagnosis information is analyzed; thereby, the state of the relevant vehicle is understood and a prospective failure state of the vehicle is monitored.

Further, in order to verify a cause of a defect of a vehicle having a low occurrence frequency, it is necessary to always record variously state information of the vehicle assumed to be required for the cause ascertainment of the defect. In addition, with respect to a defect of the vehicle having a low frequency in the detection by the user, information collection for cause ascertainment is executed based on the user's report content. It is thus necessary to always record the state information of the vehicle assumed to be required for the cause ascertainment of the defect in a wide variety.

The technology in Patent document 1, however, has a disadvantage that the data capacity of the storage media becomes huge in order to always record the above various state information in the in-vehicle system. In contrast, the technology in Patent document 2 has a disadvantage that the cost of the data communications becomes huge by transmitting the above various state information to an external vehicle service center to store.

Furthermore, the state information acquired for the cause ascertainment of the defect of the vehicle may be sometimes selected without assuming the defect with low occurrence frequency or low detection frequency. In such a case, even though the user detects the above defect, acquiring the state information may not result in the cause ascertainment.

In addition, if the cause ascertainment is achieved with respect to the defect of the vehicle having a low occurrence frequency and a low detection frequency with a difficulty in reproduction and cause identification, it is thought that contribution can be exerted to the extraction of a potential improving point.

### SUMMARY OF THE INVENTION

The present invention is made in consideration of such a disadvantage. It is an object to provide a technology to record vehicular information that contributes to a cause ascertainment of a defect which has a low occurrence frequency or a low detection frequency while having a difficulty in reproduction and identification of cause, the technology further identifying a cause of the defect based on the recorded information.

According to a first example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains (i) a class of a parameter of the vehicular information storage apparatus and (ii) a class of verification information corresponding to the parameter and a range of the verification information. The control circuit is further configured to, when the parameter of the class stipulated in the stipulation table is changed, specify the corresponding class of the verification information in the range stipulated in the stipulation table, and cause the predetermined storage media to store the verification information of the specified class and range.

According to a second example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains an automatic start-up of a predetermined vehicular system and a class and a range of the verification information corresponding to the vehicular system. The control circuit is further configured to, when the automatic start-up of the predetermined vehicular system, which is stipulated in the stipulations table is executed, specify the verification information of the corresponding class in the range stipulated in the stipulation table, and cause the predetermined storage media to store the verification information of the specified class and range.

According to a third example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a predetermined set-up content and a class and a range of the verification information corresponding to the set-up content. The control circuit is further configured to, when the set-up content, which is stipulated in the stipulations table is executed, specify the verification information of the corresponding class in the range stipulated in the stipulation table, and cause the predetermined storage media to store the verification information of the specified class and range.

According to a fourth example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a departure from a registration point and a class and a range of the verification information corresponding to the departure. The control circuit is further configured to, when the departure from the registration point, which is stipulated in the stipulation table, is executed, specify the verification information of the corresponding class in the range stipulated in the stipulation table, and cause the predetermined storage media to store the verification information of the specified class and range.

According to a fifth example of the present invention, a vehicular information storage apparatus in a vehicle is provided as follows. A state information acquisition device configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains an arrival to a destination and a class and a range of the verification information corresponding to the arrival. The control circuit is further configured to, when the arrival to the destination, which is stipulated in the stipulation table, is executed, specify the verification information of the corresponding class in the range stipulated in the stipulation table, and cause the predetermined storage media to store the verification information of the specified class and range.

According to a sixth example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a defect detection by a user and a class and a range of the verification information corresponding to the defect detection. The control circuit is further configured to, when the defect detection by the user, which is stipulated in the stipulation table, is executed, specify the verification information of the corresponding class in the range stipulated in the stipulation table, and cause the predetermined storage media to store the verification information of the specified class and range.

According to a seventh example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a reception of an instruction command and a class and a range of the verification information corresponding to the reception of the instruction command. The control circuit is further configured to, when the reception of the instruction command, which is stipulated in the stipulation table, is executed, specify the verification information of the corresponding class in the range stipulated in the stipulation table, and cause the predetermined storage media to store the verification information of the specified class and range.

According to an eighth example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. An input device is configured to be used to input information indicating that a user recognizes a defect. A control circuit is configured to stipulate information specification reference to specify verification information, which is used for verification of a defect cause, based on the information inputted via the input device, specify verification information used for verification of a defect cause out of the vehicle state information stored in the temporary storage device based on the stipulated information specification reference, and cause a predetermined storage media to store the specified verification information. The control circuit is further configured to, when the verification information is not specified, change the information specification reference and specify again verification information.

According to a ninth example of the present invention, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. A communications area determination section is configured to determine whether the vehicular information storage apparatus is inside or outside a communications area in which to communicate with an external information center. The control circuit is further configured to specify verification information, which is used for verification of a defect cause, out of the vehicle state information stored in the temporary storage device, based on the information specification reference, which is differentiated according to a determination result of either being inside or outside the communications area by the communications area determination section.

According to a tenth example of the present invention, a vehicle diagnosis system for a vehicle is provided as follows. At least one vehicular information storage apparatus according to any one of the first to ninth aspects is included. An information center is included to communicate with the at least one vehicular information storage apparatus. The at least one vehicular information storage apparatus comprises a transmission device to transmit the specified verification information to the information center. The information center comprises (i) a reception device to receive the verification information transmitted from the at least one vehicular information storage apparatus, (ii) an information storage device to store the verification information received by the reception device, and (iii) an analysis section to analyze statistically the verification information stored in the information storage device.

According to an eleventh example of the present invention, a vehicle diagnosis system for a vehicle is provided as follows. At least one vehicular information storage apparatus according to any one of the first to ninth aspects is included. An information center is included to communicate with the at least one vehicular information storage apparatus. The vehicular information storage apparatus comprises (i) an advice guidance section to perform, at a predetermined time point, an advice guidance to provide advice about a driving manipulation of the vehicle, (ii) a driving manipulation detection device to detect a driving manipulation of a user at a time point when the advice guidance is performed by the advice guidance section, (iii) a driving manipulation determination section to determine whether the detected driving manipulation accords with the provided advice, and (iv) a determination result report section to specify a position, where the driving manipulation not according with the provided advice is executed, when it is determined that the detected driving manipulation does not accord with the provided advice, and report to the information center the specified position as a discord determination result. The information center comprises (i) a determination result total section to total discord determination results received from the determination result report section of each of the at least one vehicular information storage apparatus with respect to each position, (ii) a discord number determination section to determine whether there is a position where the totaled discord determination result is greater than a predetermined value by referring to the totaled discord determination result, and (iii) an improvement position record section to record, when it is determined that there is the position where the discord determination results is greater than the predetermined value, as an improvement necessary position where a content of the advice needs to be amended.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram for illustrating a schematic configuration of a vehicle diagnosis system;

FIG. 2A is a diagram for illustrating a record data classification table;

FIG. 2B is a diagram for illustrating a record data customization table;

FIG. 3 is a flowchart diagram for illustrating a vehicle state information recording process;

FIG. 4 is a flowchart diagram for illustrating a defect detection monitoring process;

FIG. 5 is a flowchart diagram for illustrating a record mode switchover process;

FIG. 6 is a diagram for explaining a record data statistics process;

FIG. 7A is a flowchart diagram for illustrating a route selection determination process with respect to an improvement spot detection;

FIG. 7B is a flowchart diagram for illustrating a driving manipulation determination process with respect to an improvement spot detection; and

FIG. 7C is a flowchart diagram for illustrating a center statistics process with respect to an improvement spot detection.

### DETAILED DESCRIPTION OF THE PREFERRED EMBODIMENTS

Hereinafter, description will be given to an embodiment of the present invention with reference to the drawings. In addition, without need of limiting to the following explanation of the embodiment, the embodiment of the present invention can be achieved in various different manners.

### Embodiment

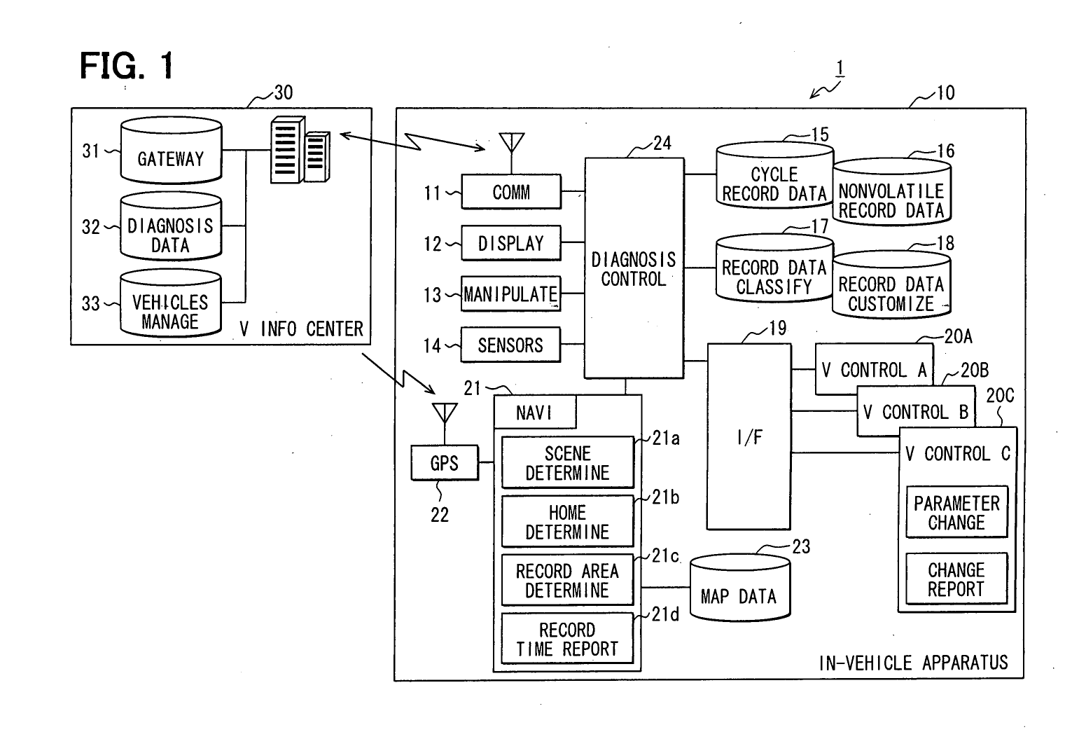

A schematic configuration of a vehicle diagnosis system 1 is illustrated in FIG. 1.

[1. Explanation of Configuration of Vehicle Diagnosis System 1]

The vehicle diagnosis system 1 includes several in-vehicle apparatuses 10 as vehicular information storage apparatuses, and a vehicle information center 30 as an information center although FIG. 1 illustrates only a single in-vehicle apparatus 10.

[1.1. Explanation of Configuration of In-Vehicle Apparatus 10]

Each in-vehicle apparatus 10 includes the following: a communications device 11, a display device 12, a manipulation device 13, various sensors 14, a cycle record data database 15, a nonvolatile record data database 16, a record data classification table database 17, a record data customization database 18, an interface (I/F) 19, vehicle control circuits 20 (20A, 20B, 20C), a navigation apparatus 21, a GPS receiver 22, a map data storage 23, and a diagnosis control circuit 24. It is noted that the diagnosis control circuit 24 is electrically connected with each constituent elements or components included in the in-vehicle apparatus 10. The diagnosis control circuit 24 can perform data exchange of transmission and reception with the constituent elements and controls of the constituent elements.

The communications device 11 transmits and receives data with the vehicle information center 30 using an antenna via a wireless communications link or media. The communications device 11 has a function of informing the diagnosis control circuit 24 of the wireless communications status of either insider or outside of a communications area for linking to or communicating with the vehicle information center 30, i.e., either a communicative status or a non-communicative status with the vehicle information center 30. Thus, the communications device 11 and the diagnosis control circuit 24 may function as a communications area determination means or device or a transmission means or device.

The display device 12 can output displays or images of information based on the result of the various processes in the in-vehicle apparatus 10. The manipulation device 13 is configured as an interface with a user of the in-vehicle apparatus 10, such as a switch and a keyboard.

The various sensors 14 acquires the state information of the vehicle accommodating the in-vehicle apparatus 10 and outputs it to the diagnosis control circuit 24. For example, the sensors 14 include a water temperature sensor, various pressure sensors, a vehicle velocity sensor, a voltage sensor, a G sensor, a yaw rate sensor, an accelerator opening sensor, a throttle opening sensor, and a shift position switch.

Thus, the various sensors 14 may function as a state information acquisition means or device. The cycle record data database 15 is constructed of a well-known rewritable memory device and is used for a temporary storage of the vehicle state information as cycle record data obtained by the various sensors 14.

Thus, the cycle record data database 15 may function as a temporary storage means or device. The nonvolatile record data database 16 is constructed of a well-known rewritable nonvolatile memory device and is used for recording the cycle record data specified based on the information specification reference stipulated in the record data classification table as nonvolatile record data.

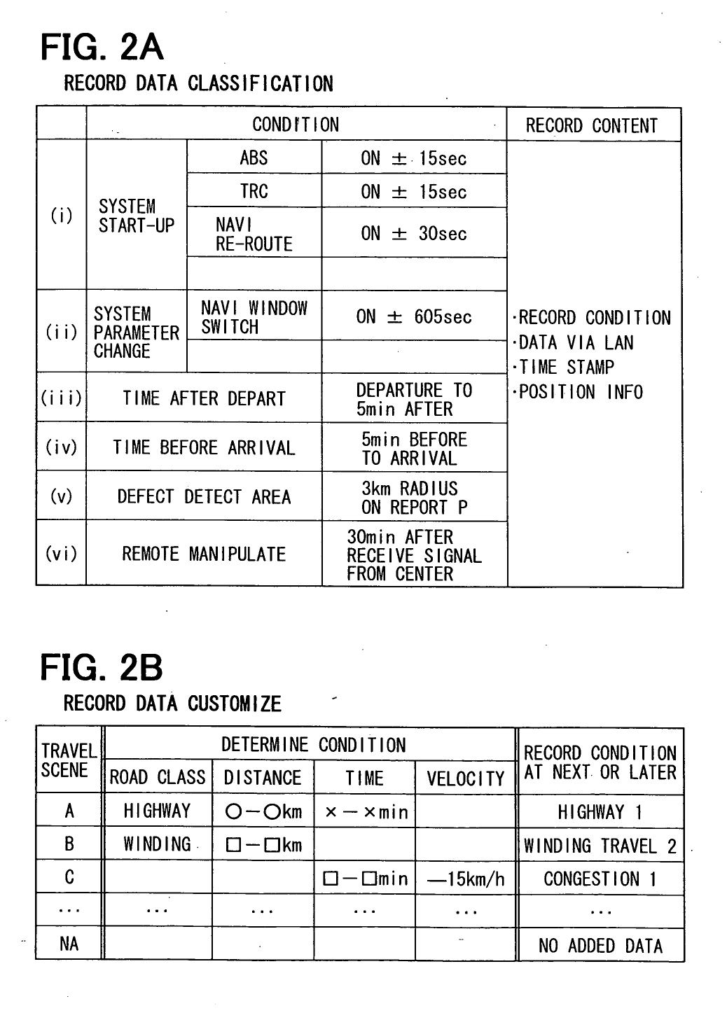

Thus, the nonvolatile record data database 16 may function as a predetermined storage media or device. The record data classification table database 17 is constructed of a well-known rewritable memory device and is used for recording the record data classification table as a stipulation table. The record data classification table is to stipulate information specification reference for specifying nonvolatile record data (verification information) which is used for verification of the defect cause out of the cycle record data stored in the cycle record data database 15. To that end, as illustrated in FIG. 2A, (i) conditions (i.e., events) and (ii) record contents serve as the information specification reference and both are registered in association with each other in the record data classification table. Such conditions or events are as follows: a system start-up; a system parameter changeover; a specified duration up to a first specified time from the time of a departure; a duration from a second specified time up to the time of an arrival; an area of a user defect detection (a user defect detection area); and an external remote manipulation. In the present embodiment, the following is registered. Specific examples of the system start-up are (i) a duration of fifteen seconds covering before and after the start-up of an anti-lock brake system (ABS), (ii) a duration of fifteen seconds covering before and after the start-up of a traction control system (TRC), and (iii) a duration of thirty seconds covering before and after the execution time for re-routing by a navigation function. A specific example of the system parameter changeover is a duration of 605 seconds covering before and after a display switchover time by the navigation function. A specific example of a first specified duration up to a first specified time from the time of the departure is a duration of five minutes from the time of the departure. A specific example of a second specified duration from a second specified time up to the time of the arrival is a duration of five minutes up to the arrival. A specific example of a user defect detection area is an area having 3 km radius centering on a position at which a defect is detected and a report is made. A specific example of the external remote manipulation is a duration of 30 minutes after receiving a control signal to the in-vehicle apparatus 10 by the operator and server of the vehicle information center 30. In addition, the record contents are exemplified as follows: a record condition of the information, information outputted to the in-vehicle LAN, a time stamp of the information outputted to the in-vehicle LAN, and position information (latitude, longitude, road class, etc.).

The record data classification, table database 17 may function as a stipulation table storage means or device. The record data customization database 18 is constructed of a well-known rewritable memory device and is used for recording the record data customization table. The record data customization table is to stipulate conditions for changing the record conditions stipulated in the record data classification table; therefore, travel scenes that are previously designated or set up are registered in the record data customization table as illustrated in FIG. 2B. Each travel scene is stored in association with a travel scene determination condition and a record condition for the next time or later. In addition, the travel scene determination condition contains information on road class, travel distance (i.e., trip value), travel time, and travel velocity. In the present embodiment, with respect to the travel scene A, a highway as a road class, a specific value of a travel distance, a specific value of a travel time, and a high velocity travel as a record condition for the next time or later are registered. With respect to a travel scene B, a winding as the road class, a specific value of a travel distance, and a winding travel as a record condition for the next time or later are registered. With respect to the travel scene C, a specific value of a travel time, a specific value of a travel velocity, and a congestion travel as a record condition for the next time or later are registered.

The vehicle control circuit 20 is, for example, a computer unit in which a CPU as a main part is mutually connected with ROM, RAM, or the like via a bus line; the vehicle control circuit 20 further includes an internal memory, an I/O port, a timer, a counter, etc. The ROM stores data and programs executed by the CPU. The programs include a vehicle control program for the vehicle control, a program for vehicle state monitoring process and information storing process. The vehicle control circuit 20 is connected with an in-vehicle apparatus (unshown) serving as a control target via the multiplex communications link. Such in-vehicle apparatus include an actuator, an engine, a transmission, a braking apparatus, and a steering apparatus. In FIG. 1, three vehicle control circuits 20A to 20C are illustrated. For example, the vehicle control circuit 20C executes a parameter change function to change various parameters of the in-vehicle apparatus 10, and an operation/change notification function to report various operations and various changes.

The navigation apparatus 21 is a well-known apparatus which can executes a navigation function and connected with a well-known GPS receiver 22 for detecting a position of the subject vehicle and a well-known map data storage 23 which stores map data.

In addition, the navigation apparatus 21 can further execute the following functions: a travel scene determination function 21a, a home-vicinity departure/arrival determination function 21b, a diagnosis specification record area determination function 21c, and a diagnosis record time determination function 21d. The travel scene determination function 21a is to determine a travel scene of the subject vehicle where the in-vehicle apparatus 10 is mounted. For instance, the travel scene includes a high velocity travel, a winding travel, a traffic congestion travel. The home-vicinity departure/arrival determination function 21b is to determine the start and arrival in the vicinity of home. The diagnosis specification record area determination function 21c is to determine whether the vehicle having the in-vehicle apparatus 10 is located in the record area in which to specify diagnosis. In addition, the diagnosis record time determination function is to determine the time at which to record a diagnosis.

The diagnosis control circuit 24 is a commonly known device to mainly include a microcomputer equipped with CPU, ROM, RAM, etc., and controls each component or device of the configuration mentioned above. The diagnosis control circuit 24 executes various processes according to a program read from the ROM or RAM. In addition, the diagnosis control circuit 24 executes each of a vehicle state information recording process, a defect detection monitoring process, and a recording mode changeover process mentioned later.

In addition, the diagnosis control circuit 24 is connected with the vehicle control circuit 20 mounted in the vehicle via the I/F 19 while receiving various signals outputted from the vehicle control circuit 20 and outputting control signals for controlling the vehicle control circuit 20.

In addition, the diagnosis control circuit 24 has a function to read the nonvolatile record data recorded in the nonvolatile record data database 16, and controls the communications device 11 so as to transmit the read nonvolatile record data as diagnosis data to the vehicle information center 30.

The diagnosis control circuit 24 may function as a state information acquisition means or device or a control means or device.

[1.2. Explanation of Configuration of Vehicle Information Center]

The vehicle information center 30 includes a gateway 31, a diagnosis data database 32, and a vehicle management database 33.

The gateway 31 transmits and receives data with the in-vehicle apparatus 10 using an antenna via a wireless communications media. The gateway 31 may function as a reception means or device. The diagnosis data database 32 is constructed of a well-known rewritable memory device and is used for recording or storing diagnosis data received by the gateway 31 from the in-vehicle apparatus 10. The diagnosis data recorded in the diagnosis data database 32 is statistically analyzed in the vehicle information center 30 and is used for identifying a cause of the defect (refer to “detect defect” in FIG. 6). Thus, the diagnosis data database 32 may function as a verification information storage means or device.

The vehicle management database 33 is constructed of a well-known rewritable memory device and is used for recording as vehicle management data the result from the statistical analysis of the diagnosis data recorded in the diagnosis data database 32 by the vehicle information center 30.

The vehicle information center 30 may function as an analysis means or device.

[2. Explanation of Processes by Vehicle Diagnosis System]

Next, the following explains the various processes executed by the vehicle diagnosis system 1.

[2.1. Explanation of Vehicle State Information Recording Process]

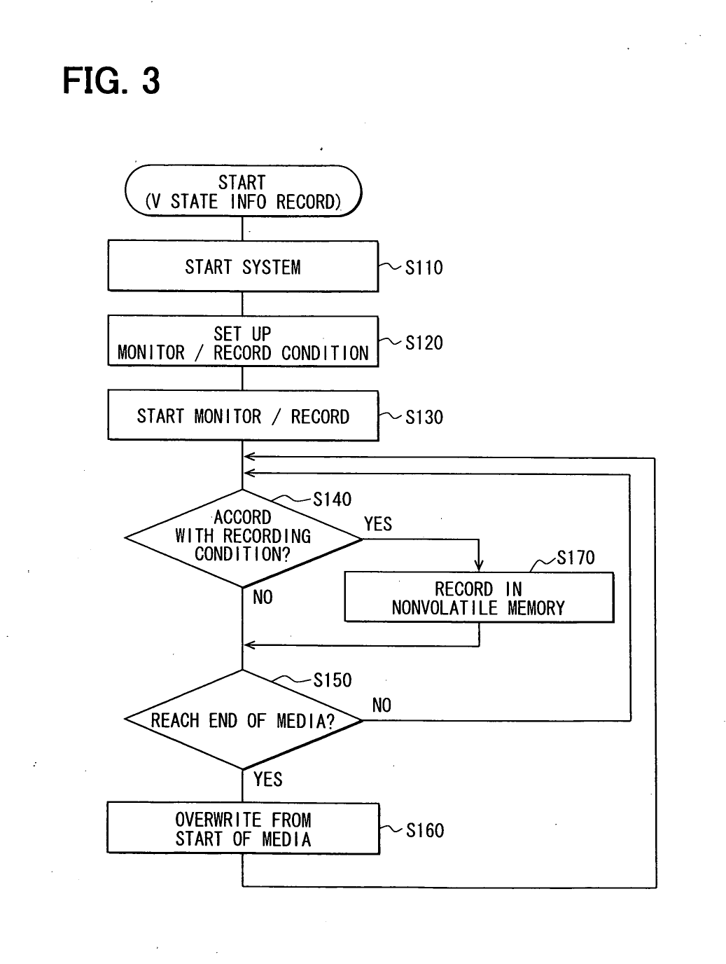

First, the vehicle state information recording process which the diagnosis control circuit 24 of the in-vehicle apparatus 10 executes is explained with reference to a flowchart of FIG. 3.

The present process is executed independently from other processes when the accessory power source (unshown) of the vehicle is turned into an ON state and the in-vehicle apparatus 10 is supplied with a power source. It is further noted that a flowchart or the processing of the flowchart in the present application includes sections (also referred to as steps), which are represented, for instance, as S110. Further, each section can be divided into several sub-sections while several sections can be combined into a single section. Furthermore, each of thus configured sections can be referred to as a means or unit and achieved not only as a software device but also as a hardware device. First, at S110, a system for monitoring and recording the state information of the vehicle is started. The system is started by reading from the RAM the program for the diagnosis control circuit 24 to monitor and record the state information of the vehicle and executing the read program.

At S20, a condition is designated or set up which performs monitoring and recording of a defect of the vehicle. In detail, the record data classification table which the record data classification table database 17 stores is read. The information specification reference (the conditions and the record contents) stipulated in the read record data classification table is designated or set up as the conditions which perform monitoring and recording of a defect of the vehicle.

At S130, the monitoring and recording of a defect of the vehicle are started based on the designated conditions. In detail, while monitoring the state information of the vehicle which the various sensors 14 acquire, the diagnosis control circuit 24 temporarily records in the cycle record data database 15 the acquired state information of the vehicle as cycle record data.

At S140, it is determined whether the state information accords with a condition (conditions designated at S120) for recording in the nonvolatile record data database 16. In the present embodiment, the determination is affirmed when one of the conditions registered in the record data classification table exemplified in FIG. 2A is fulfilled. Again, the conditions include the following: (i) in cases that a system is started; (ii) in cases that a system parameter is changed; (iii) in cases that it reaches a specified time after the departure; (iv) in cases that it reaches a specified time before the arrival; (v) in cases that a subject vehicle is located in a user defect detection area; and (vi) in cases that an external remote manipulation is executed.

When it is determined that the vehicle state information accords with a condition for recording in the nonvolatile record data database 16 (S140: YES), the cycle record data meeting with the record content corresponding to the condition determined to be fulfilled are retrieved from the whole of the cycle record data recorded in the cycle record data database 15. The retrieved cycle record data are recorded in the nonvolatile record data database 16 as nonvolatile record data (S170): Then the processing advances to S150 to be mentioned later.

In contrast, when it is not determined that the vehicle state information accords with a condition for recording in the nonvolatile record data database 16 (S140: NO), the processing directly advances to S150. At S150, it is determined whether the position at which to record the cycle record data reaches the terminating end of the cycle record data database 15.

When it is determined that the position at which to record the cycle record data reaches the terminating end of the cycle record data database 15 (S150: YES), the position at which to record the cycle record data is changed into the starting end of the cycle record data database 15 and overwriting in the cycle record data database 15 is started (S160), thereby advancing the processing to S140.

In contrast, when it is not determined that the position at which to record the cycle record data reaches the terminating end of the cycle record data database 15 (S150: NO), recording in the cycle record data database 15 is continuously executed, thereby returning the processing to S140.

[2.2. Explanation of Defect Detection Monitoring Process]

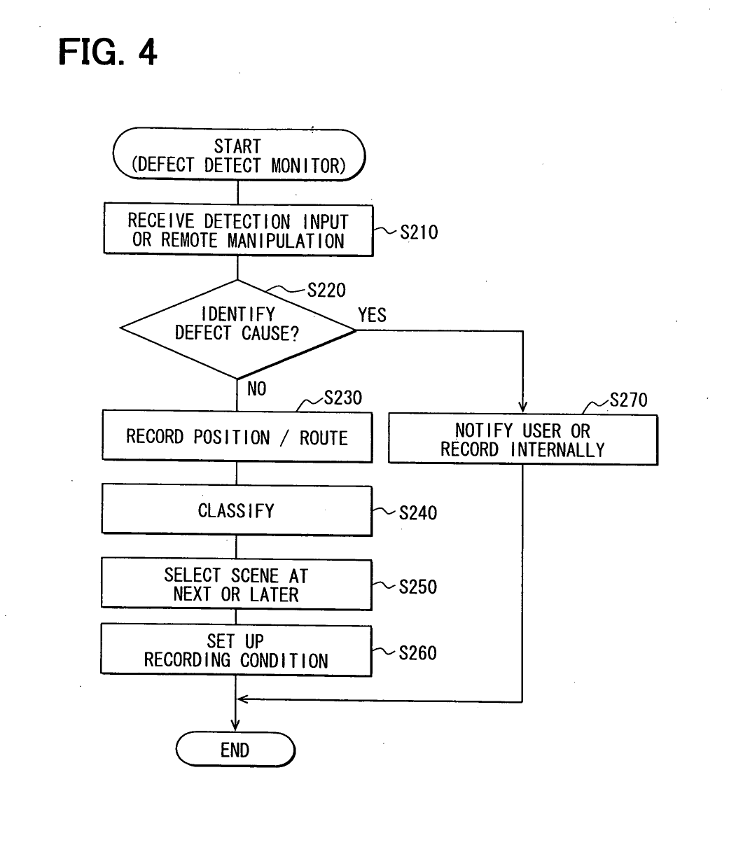

Next, the defect detection monitoring process which the diagnosis control circuit 24 of the in-vehicle apparatus 10 executes is explained with reference to the flowchart of FIG. 4.

The present process is repeatedly executed independently from other processes such as the vehicle state information recording process, when the accessory power source (unshown) of the vehicle is turned into an ON state and the in-vehicle apparatus 10 is supplied with a power source. First, at S210, the diagnosis control circuit 24 accepts an input of a user signifying that the user detected a defect or an input of an instruction command by an operator's remote manipulation. The input executed by the user is via the manipulation device 13. In addition, the instruction command is transmitted to the in-vehicle apparatus 10 by the operator of the vehicle information center 30 which receives a report by the user who detects a defect. The processing stands by at S210 until an input by the user or an input of the instruction command is received. When an input is received, the processing advances to S220.

At S220, it is determined whether the cause identification is possible with respect to the defect detected by the user. The technique for the cause identification follows the well-known technology, therefore omitting detailed explanation.

When it is determined that the cause identification is possible with respect to the defect (S220: YES), the diagnosis control circuit 24 executes a report, which indicates that the cause identification is possible, to the user, or a record within the system, at S270. The present process is then ended. In contrast, when it is not determined that the cause identification is possible with respect to the defect (S220: NO), the processing advances to S230.

At S230, the present position of the subject vehicle and the route just traveled up to the present time are recorded in the RAM. At S240, classification is made with respect to the road class, the travel distance, the travel time, and the travel velocity based on the record contents recorded at S230 such as the present position of the subject vehicle and the route just before.

At S250, with reference to the record data customization table illustrated in FIG. 2B, the travel scene recorded at the next time or later is selected. At S260, the condition used in the vehicle state information recording process is changed into the record condition corresponding to the travel scene selected at S250. The present process is then ended.

[2.3. Explanation of Record Mode Switchover Process]

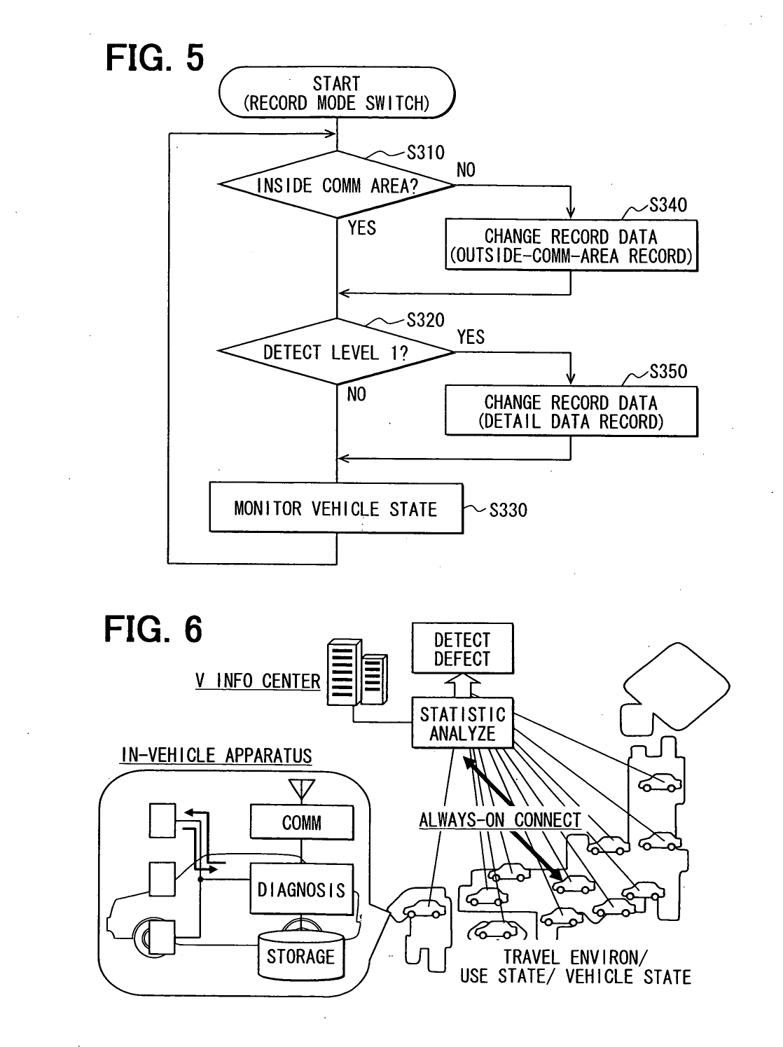

Next, the record mode switchover process which the diagnosis control circuit 24 of the in-vehicle apparatus 10 executes is explained with reference to the flowchart of FIG. 5.

The present process is repeatedly executed independently from other processes such as the vehicle state information recording process and defect detection monitoring process when the accessory power source (unshown) of the vehicle is turned into an ON state and the in-vehicle apparatus 10 is supplied with a power source.

First, at S310, it is determined whether the subject vehicle is located inside the communications area in which to able to communicate with the vehicle information center 30. When it is determined that the subject vehicle is located outside the communications area in which to communicate with the vehicle information center 30 (S310: NO), the method for the data record is changed into “record outside of the communications area” at S340. The processing then advances to S320. With respect to the record outside of the communications area, when the cycle record data specified based on the information specification reference stipulated in the record data classification table is recorded as nonvolatile record data, recording of the data in the nonvolatile record data database 16 is restricted and reduced by thinning out.

In contrast, when it is determined that the subject vehicle is located within the communications area in which to communicate with the vehicle information center 30 (S310: YES), the processing directly advances to S320. At S320, it is determined whether the defect of level 1 is detected. It is noted that “level 1” is assigned to a defect with the highest degree of seriousness, when the defects are classified in respect of the seriousness.

When the defect with the level 1 is determined to be detected (S320: YES), the data recording method is changed into “detailed data record” at S350. The processing then advances to S330. It is noted that, with respect to the detailed data record, unlike the above-mentioned record outside of the communications area, the cycle record data specified based on the information specification reference stipulated in the record data classification table is recorded as it is directly as nonvolatile record data in the nonvolatile record data database 16 without any restriction.

When the defect with the level 1 is determined to be not detected (S320: NO), the processing directly advances to S330. At S330, the travel state of the vehicle is monitored. In detail, so as to follow the designated record method, the cycle record data specified based on the information specification reference stipulated in the record data classification table are recorded as it is directly as nonvolatile record data in the nonvolatile record data database 16 without any restriction. The processing then returns to S310.

[2.4. Explanation of Improvement Spot Detection Process]

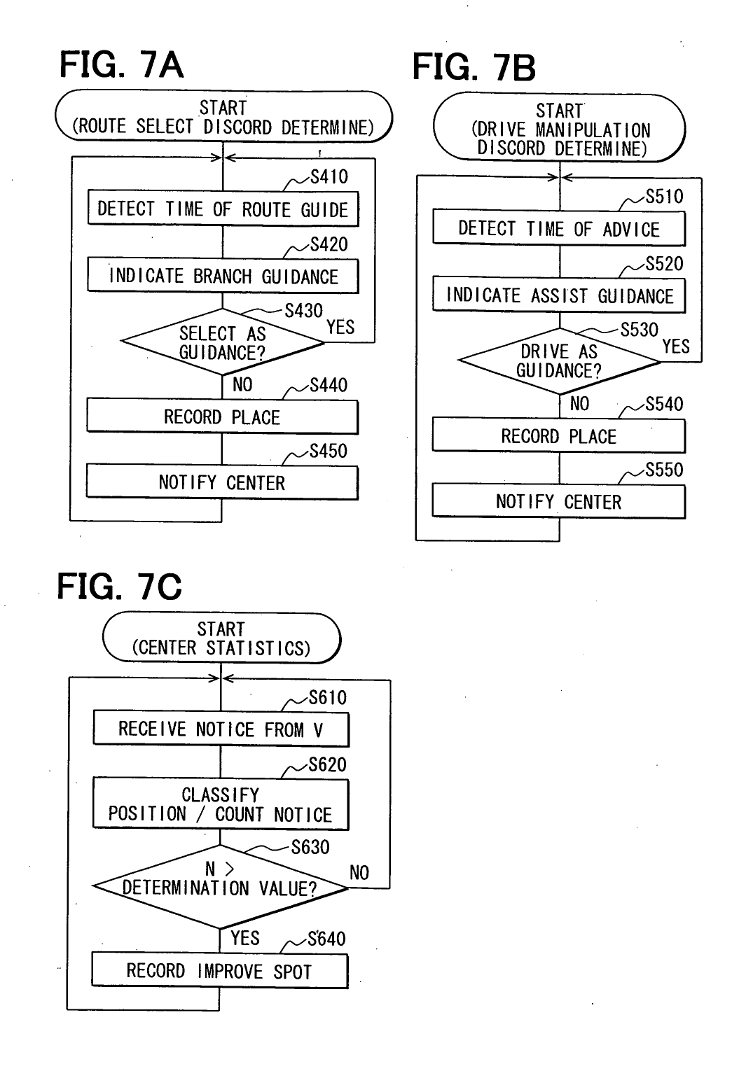

Next, the improvement spot detection process is explained with reference to the flowchart of FIGS. 7A to 7C. The improvement spot detection process includes a route selection determination process which the diagnosis control circuit 24 of the in-vehicle apparatus 10 executes (refer to FIG. 7A), a driving manipulation determination process which the diagnosis control circuit 24 of the in-vehicle apparatus 10 executes (refer to FIG. 7B), and a center statistics process which the vehicle information center 30 executes (refer to FIG. 7C). Those processes are explained in order.

[2.4.1. Explanation of Route Selection Determination Process]

First, the route selection determination process which the diagnosis control circuit 24 of the in-vehicle apparatus 10 executes is explained with reference to the flowchart of FIG. 7A. First, at S410, the time point at which a route guidance is executed is detected. At S420, a branching guidance is executed at a predetermined time point. At S430, it is determined whether the route meeting the branching guidance at S420 is selected. When the route meeting the branching guidance is selected (S430: YES), the processing returns to S410. In contrast, when the route meeting the branching guidance is not selected (S430: NO), the processing advances to S440. At S440, the place at which the route meeting the branching guidance at S420 is not selected is specified, and the specified place is recorded. At S450, the place recorded at S440 is notified to the vehicle information center 30 as a discord determination result. Such a discord determination result may be notified to the information center 30 by containing a guidance content at the place (display window ID), a guidance route (i.e., a planned guidance route in the route guidance), an entrance road (i.e., a planned entrance road in the route guidance), an exit road (i.e., a planned exit road in the route guidance), an actual exit road (i.e., an actually traveled exit road in the actually traveled route by a user), and a driving environment at that time of actually traveling (entrance time, exist time, time zone, etc.). The processing then returns to S410.

[2.4.2. Explanation of Driving Manipulation Determination Process]

Next, the driving manipulation determination process which the diagnosis control circuit 24 of the in-vehicle apparatus 10 executes is explained with reference to the flowchart of FIG. 7B. First, at S510, the time point at which a travel assistance advice is executed is detected. At S520, the travel assistance guidance is executed at a predetermined time point. At S530, it is determined whether the driving manipulation meeting the guidance is executed. When the driving manipulation meeting the guidance is executed (S530: YES), the processing returns to S510. In contrast, when the driving manipulation meeting the guidance is not executed (S530: NO), the processing advances to S540. At S540, the place at which the driving manipulation meeting the guidance at S520 is not executed is specified, and the specified place is recorded. At S550, the place recorded at S540 is notified to the vehicle information center 30 as a discord determination result. Such a discord determination result is notified to the information center 30 by containing the following: a guidance content at the specified place such as a travel road map ID and a travel assistance guidance ID, a driving environment at that time such as an entrance clock time, an exit clock time, a time zone, a vehicle velocity after the guidance, an acceleration, an accelerator manipulation after the guidance, brake manipulation information, and a user's manipulation after the guidance. The processing then returns to S510.

[2.4.3. Explanation of Center Statistics Process]

Next, the center statistics process for improvement spot detection executed by the vehicle information center 30 is explained with reference to the flowchart of FIG. 7C. First, at S610, the information center 30 receives a discord determination result from the in-vehicle apparatus 10. At S620, a position classification notification count is executed. In detail, the received discord determination results are totaled for every spot; thereby, the number (N) of times in occurrence of the discord determination result at the corresponding place is incremented. At S630, it is determined whether the number N is greater than a predetermined determination value. In detail, it is determined whether there is existing a spot (i.e., position) undergoing the discord determination results greater than the predetermined determination value; thereby, it is determined whether the number N of times in the occurrences in the discord determination results at the position corresponding to the received discord determination results is greater than the predetermined determination value. When the number N is equal to less than the determination value (S630: NO), the processing returns to S610. In contrast, when the number N is greater than the determination value (S630: YES), the processing advances to S640. At S640, the spot where it is determined at S630 that the number N is greater than the determination value, i.e., the spot where the number of discord determination results is greater than the predetermined value is recorded as an improvement spot that is a spot at which to need to improve route guidance or a content of the travel assistance. When storing the improvement spot, the variety of information may be obtained from the in-vehicle apparatus 10 and recorded collectively as the information (user information) generating the discord determination results at the improvement spot. The variety of information may include a user's age, sex and an attributes of the spot such as a residential area, home, a place of work, etc., and an area for the user to frequently travel, etc. In addition, after detecting the improvement spot as mentioned above, it can be designed that the vehicle information center 30 executes a daily basis improvement by distributing to the in-vehicle apparatus 30 a modified version of a navigational map or a travel assistance advice corresponding to the improvement spot. The processing then returns to S610. In the improvement spot detection process, the display device 12 and the diagnosis control circuit 24 of the in-vehicle apparatus 10 may function as an advice guidance means or device; the various sensors 14 may function as a driving manipulation detection means or device; the control circuit 24 may function as a driving manipulation determination means or section and a determination result report means or section. In addition, the vehicle information center 30 may function as a determination result total means or section, a discord times determination means or section, and an improvement spot record means or section.

[3. Effect of Embodiment]

(1) According to the vehicle diagnosis system 1 of the present embodiment, in cases that the in-vehicle apparatus 10 fulfills one of the conditions registered in the record data classification table, the accord with a condition for recording in the nonvolatile record data database is determined (S140: YES). Fulfillment of such conditions is made (i) in cases that a predetermined vehicular system starts; (ii) in cases that a predetermined vehicular system parameter is changed; (iii) in cases that it reaches a specified time after the departure of the subject vehicle; (iv) in cases that it reaches a specified time before the arrival of the subject vehicle; (v) in cases that a subject vehicle is located in a user defect detection area; or (vi) in cases that a predetermined external remote manipulation is executed or received by the subject vehicle. Then, out of the cycle record data recorded in the cycle record data database 15, the cycle record data meeting with the record content corresponding to the condition determined to be fulfilled is searched for and read. The read meeting cycle record data is recorded in the nonvolatile record data database 16 as nonvolatile record data (S170).

When the condition is fulfilled, i.e., (i) in cases that the predetermined vehicular system is started, (ii) in cases that a vehicular system parameter is changed; (iii) in cases that it reaches a specified time after the departure; (iv) in cases that it reaches a specified time before the arrival; (v) in cases that a subject vehicle is located in a user defect detection area; or (vi) in cases that an external remote manipulation is executed, a defect having a low occurrence frequency and a low detection frequency with a difficulty in reproduction and cause identification may sometimes occur. The vehicle diagnosis system 1 according to the present embodiment can record vehicular information that contributes to a cause ascertainment of a defect which has a low occurrence frequency or a low detection frequency while having a difficulty in reproduction and identification of cause.

(2) In addition, the vehicle diagnosis system 1 of the present embodiment executes as follows. An input of a user signifying that the user detected a defect or an input of an instruction command by an operator's remote manipulation is accepted (S210). When the cause identification is not possible with respect to the defect (S220: NO), the classification is made with respect to the road class, travel distance, travel time, and travel velocity based on the present position of the subject vehicle and the route just before (S240). The record data customization table is referred to, and the travel scene to be recorded at the next time or later is selected. The condition used in the vehicle state information recording process is changed into the recording condition corresponding to the selected travel scene. This can provide a technology to record vehicular information that contributes to a cause ascertainment of a defect which has a low occurrence frequency or a low detection frequency while having a difficulty in reproduction and identification of cause.

(3) In addition, the vehicle diagnosis system 1 of the present embodiment executes as follows. When it is determined that the subject vehicle is located outside of the communications area in which to communicate with the vehicle information center 30 (S310: NO), the method of data recording is changed into “record outside of the communications area” (S340). the cycle record data specified based on the information specification reference stipulated in the record data classification table are recorded as nonvolatile record data in the nonvolatile record data database 16 with restriction relative to the recording by thinning out. In contrast, when it is determined that the subject vehicle is located within the communications area in which to communicate with the vehicle information center 30 (S310: YES), the method of data recording is changed into “detailed data record” at S350. Thus, unlike outside of the communications area, the cycle record data specified based on the information specification reference stipulated in the record data classification table are recorded as it is directly as nonvolatile record data in the nonvolatile record data database 16 without any restriction. Such a configuration can respond to the following unfavorable state. The storage capacity of the nonvolatile record data database 16 is small; the in-vehicle apparatus 10 is located outside of the communications area, disabling the communications with the vehicle information center 30. In such a state, it is impossible for the in-vehicle apparatus 10 to transmit the nonvolatile record data as diagnosis data to the vehicle information center 30 to store. In such an unfavorable state, reducing of the nonvolatile record data to specify can decrease as much as possible the deleted amount of the nonvolatile record data.

(4) In addition, the vehicle diagnosis system 1 of the present embodiment executes as follows. The vehicle information center 30 records the diagnosis data received from the in-vehicle apparatus 10 in the diagnosis data database 32. The diagnosis data recorded in the diagnosis data database 32 is used for statistical analysis to identify the cause of the defect. Thus, the cause ascertain can be made with respect to the defect having a low occurrence frequency and a low detection frequency with a difficulty in reproduction and cause identification. (5) In addition, the vehicle diagnosis system 1 of the present embodiment executes as follows. The execution of the improvement spot detection process is to detect and record a matter not meeting the user's intension although it is not a defect in design, with respect to the advice about the driving manipulation, thereby effectively extracting the improvement point or spot of the advice about the driving manipulation of the vehicle. For example, the extracted information can be used for confirming the actual location of the corresponding spot; thereby, an unsuitable point is understood for measuring optimization with respect to the improvement of the system such as a guidance map being not easily illustrated or being not followed due to the slope or travel status of the surrounding vehicles. For example, there is a case that a user pushes a switch to execute a deletion of an enlargement display when the system automatically displays an enlargement map of an intersection at a guidance of branching. Further, there is another case that a user executes a driving manipulation for branching (right/left turn) different from that (going straight) indicated by the executed guidance. In each case, re-route guidance may be executed at the improvement spot. In addition, there are many cases that when users maintain excessive velocity or execute accelerations against the advice of deceleration at the front sharp curve in the travel assistance. At this improvement spot, instead of the safe driving advice, the eco-driving advice may be made to indicate the restraint of sudden acceleration, maintaining the present velocity, or deceleration start, etc.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a non-transitory computer-readable storage media or can be downloaded and installed in a non-transitory computer-readable storage media via a communications network.

Aspects of the disclosure described herein are set out in the following clauses.

According to a first aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains (i) a class of a parameter of the vehicular information storage apparatus and (ii) a class of verification information corresponding to the parameter and a range of the verification information. The control circuit is further configured to, when the parameter of the class stipulated in the stipulation table is changed, specify the corresponding class of the verification information in the range stipulated in the stipulation table, and cause the predetermined storage media to store the verification information of the specified class and range.

Herein, when a predetermined parameter of the vehicular information storage apparatus is changed, there may be a case of arising a defect having a low occurrence frequency and a low detection frequency with a difficulty in reproduction and cause identification. The above configuration can respond to such a case. Further, such a parameter change is, for instance, explained in the embodiment as the system parameter changeover being a display switchover of a navigation function.

As an optional aspect of the first aspect, the stipulation table may stipulate as a range to specify the verification information a predetermined time duration which includes a time when the parameter is changed.

According to a second aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains an automatic start-up of a predetermined vehicular system and a class and a range of the verification information corresponding to the vehicular system. The control circuit is further configured to, when the automatic start-up of the predetermined vehicular system, which is stipulated in the stipulations table is executed, specify the verification information of the corresponding class in the range stipulated in the stipulation table, and cause the predetermined storage media to store the verification information of the specified class and range.

Herein, when automatic start-up of a vehicular system in the vehicular information storage apparatus is executed, there may be a case of arising a defect having a low occurrence frequency and a low detection frequency with a difficulty in reproduction and cause identification. The above configuration can respond to such a case. Further, such a vehicular system is, for instance, explained in the embodiment as an anti-lock brake system (ABS), (ii) a traction control system (TRC), (iii) a re-routing by a navigation function, and, further, (iv) the vehicular information storage apparatus itself.

As an optional aspect of the second aspect, the stipulation table may stipulate as a range to specify the verification information a predetermined time duration which includes a time when the automatic start-up of the predetermined vehicular system is executed.

According to a third aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a predetermined set-up content and a class and a range of the verification information corresponding to the set-up content. The control circuit is further configured to, when the set-up content, which is stipulated in the stipulations table is executed, specify the verification information of the corresponding class in the range stipulated in the stipulation table, and cause the predetermined storage media to store the verification information of the specified class and range.

Herein, when a set-up content of the vehicular information storage apparatus is changed, there may be a case of arising a defect having a low occurrence frequency and a low detection frequency with a difficulty in reproduction and cause identification. The above configuration can respond to such a case. Further, such a change of a set-up content is, for instance, explained in the embodiment as the system parameter changeover being a display switchover of a navigation function.

As an optional aspect of the third aspect, the stipulation table may stipulate as a range to specify the verification information a predetermined time duration which includes a time when the predetermined set-up content is changed.

According to a fourth aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a departure from a registration point and a class and a range of the verification information corresponding to the departure. The control circuit is further configured to, when the departure from the registration point, which is stipulated in the stipulation table, is executed, specify the verification information of the corresponding class in the range stipulated in the stipulation table, and cause the predetermined storage media to store the verification information of the specified class and range.

Herein, when the vehicle having the vehicular information storage apparatus departs from a registration point, there may be a case of arising a defect having a low occurrence frequency and a low detection frequency with a difficulty in reproduction and cause identification. The above configuration can respond to such a case. Further, such a registration point, for instance, explained in the embodiment as home, which is detected by a home-vicinity arrival/departure determination function of the navigation apparatus.

As an optional aspect of the fourth aspect, the stipulation table may stipulate as a range to specify the verification information a predetermined time duration which includes a time when the departure from the registration point is made.

According to a fifth aspect of the disclosure, a vehicular information storage apparatus in a vehicle is provided as follows. A state information acquisition device configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains an arrival to a destination and a class and a range of the verification information corresponding to the arrival. The control circuit is further configured to, when the arrival to the destination, which is stipulated in the stipulation table, is executed: specify the verification information of the corresponding class in the range stipulated in the stipulation table, and cause the predetermined storage media to store the verification information of the specified class and range.

Herein, when the vehicle having the vehicular information storage apparatus reaches a destination, there may be a case of arising a defect having a low occurrence frequency and a low detection frequency with a difficulty in reproduction and cause identification. The above configuration can respond to such a case. Further, such a destination, for instance, explained in the embodiment as home, which is detected by a home-vicinity arrival/departure determination function of the navigation apparatus.

As an optional aspect of the fifth aspect, the stipulation table may stipulate as a range to specify the verification information a predetermined time duration which includes a time when, the arrival to the destination is made.

According to a sixth aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates'an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a defect detection by a user and a class and a range of the verification information corresponding to the defect detection. The control circuit is further configured to, when the defect detection by the user, which is stipulated in the stipulation table, is executed, specify the verification information of the corresponding class in the range stipulated in the stipulation table, and cause the predetermined storage media to store the verification information of the specified class and range.

Herein, when a defect detection is made by a user, there may be a case of arising a defect having a low occurrence frequency and a low detection frequency with a difficulty in reproduction and cause identification. The above configuration can respond to such a case.

As an optional aspect of the sixth aspect, the stipulation table may stipulate as a range to specify the verification information a predetermined vicinity of a place where the defect detection is made by the user.

As another optional aspect of the sixth aspect, the stipulation table may stipulate, as a range to specify the verification information, verification information acquired under a same travel condition as a travel condition at a time when the defect detection is made by the user.

According to a seventh aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. Herein, the information specification reference in the stipulation table contains a reception of an instruction command and a class and a range of the verification information corresponding to the reception of the instruction command. The control circuit is further configured to, when the reception of the instruction command, which is stipulated in the stipulation table, is executed, specify the verification information of the corresponding class in the range stipulated in the stipulation table, and cause the predetermined storage media to store the verification information of the specified class and range.

Herein, when a instruction command is received, there may be a case of arising a defect having a low occurrence frequency and a low detection frequency with a difficulty in reproduction and cause identification. The above configuration can respond to such a case. Further, such a instruction command, for instance, explained in the embodiment as an input by a user or remote manipulation by an operator.

As an optional aspect of the seventh aspect, the stipulation table may stipulate as a range to specify the verification information a predetermined time duration which starts from a time when the reception of the instruction command is made.

Such a configuration can provide a technology to record vehicular information that contributes to a cause ascertainment of a defect which has a low occurrence frequency or a low detection frequency while having a difficulty in reproduction and identification of cause.

According to an eighth aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. An input device is configured to be used to input information indicating that a user recognizes a defect. A control circuit is configured to stipulate information specification reference to specify verification information, which is used for verification of a defect cause, based on the information inputted via the input device, specify verification information used for verification of a defect cause out of the vehicle state information stored in the temporary storage device based on the stipulated information specification reference, and cause a predetermined storage media to store the specified verification information. The control circuit is further configured to, when the verification information is not specified, change the information specification reference and specify again verification information.

Such a configuration can provide a technology to record vehicular information that contributes to a cause ascertainment of a defect which has a low occurrence frequency or a low detection frequency while having a difficulty in reproduction and identification of cause.

According to a ninth aspect of the disclosure, a vehicular information storage apparatus in a vehicle is provided as follows. A state information acquisition device is configured to acquire vehicle state information of the vehicle. A temporary storage device is configured to store temporarily the vehicle state information acquired by the state information acquisition device. A stipulation table storage device is configured to store a stipulation table that stipulates an information specification reference for specifying verification information, which is used for verification of a defect cause, out of the vehicle state information stored in the temporary storage device. A control circuit is configured to specify verification information used for verification of a defect cause from the vehicle state information stored in the temporary storage device based on the information specification reference stipulated in the stipulation table, and cause a predetermined storage media to store the specified verification information. A communications area determination section is configured to determine whether the vehicular information storage apparatus is inside or outside a communications area in which to communicate with an external information center. The control circuit is further configured to specify verification information, which is used for verification of a defect cause, out of the vehicle state information stored in the temporary storage device, based on the information specification reference, which is differentiated according to a determination result of either being inside or outside the communications area by the communications area determination section.

As an optional aspect of the ninth aspect, when it is determined that the apparatus is located outside the communications area, the control circuit may be further configured to specify the verification information in a predetermined range, which is less than a predetermined range where the verification information is specified when it is determined that the apparatus is inside the communications area.

As another optional aspect of the ninth aspect, when it is determined that the apparatus is located outside the communications area, the control circuit may be further configured to thin out in specifying the verification information.

Suppose a status where the storage capacity of the predetermined storage medium is small and the vehicular information storage apparatus is outside the communications area to thereby disable the transmission of the verification information to the external information center. In such an unfavorable state, reducing of the verification information to specify can decrease as much as possible the amount of the verification information to delete.

According to a tenth aspect of the disclosure, a vehicle diagnosis system for a vehicle is provided as follows. At least one vehicular information storage apparatus according to any one of the first to ninth aspects is included. An information center is included to communicate with the at least one vehicular information storage-apparatus. The at least one vehicular information storage apparatus comprises a transmission device to transmit the specified verification information to the information center. The information center comprises (i) a reception device to receive the verification information transmitted from the at least one vehicular information storage apparatus, (ii) an information storage device to store the verification information received by the reception device, and (iii) an analysis section to analyze statistically the verification information stored in the information storage device.

Such a configuration can provide a technology to record vehicular information that contributes to a cause ascertainment of a defect which has a low occurrence frequency or a low detection frequency while having a difficulty in reproduction and identification of cause.

According to an eleventh aspect of the disclosure, a vehicle diagnosis system for a vehicle is provided as follows. At least one vehicular information storage apparatus according to any one of the first to ninth aspects is included. An information center is included to communicate with the at least one vehicular information storage apparatus. The vehicular information storage apparatus comprises (i) an advice guidance section to perform, at a predetermined time point, an advice guidance to provide advice about a driving manipulation of the vehicle, (ii) a driving manipulation detection device to detect a driving manipulation of a user at a time point when the advice guidance is performed by the advice guidance section, (iii) a driving manipulation determination section to determine whether the detected driving manipulation accords with the provided advice, and (iv) a determination result report section to specify a position, where the driving manipulation not according with the provided advice is executed, when it is determined that the detected driving manipulation does not accord with the provided advice, and report to the information center the specified position as a discord determination result. The information center comprises (i) a determination result total section to total discord determination results received from the determination result report section of each of the at least one vehicular information storage apparatus with respect to each position, (ii) a discord number determination section to determine whether there is a position where the totaled discord determination result is greater than a predetermined value by referring to the totaled discord determination result, and (iii) an improvement position record section to record, when it is determined that there is the position where the discord determination results is greater than the predetermined value, as an improvement necessary position where a content of the advice needs to be amended.

That is, with respect to such an occurrence point of a discord determination, not only a single user but also other users may undergo or detect a discord. Such a case enables the detection that the above-mentioned advice does not accord with intentions of the users. It is noted that an example of the advice relative to the driving manipulation to the vehicle is a route guidance, travel assist guidance. According to the above vehicle diagnosis system, a matter, which is not a defect but does not meet the user's intension, is detected and recorded with respect to the advice about the driving manipulation, thereby effectively extracting the improvement point of the advice about the driving manipulation of the vehicle. For example, the extracted information can be used for confirming the actual location of the corresponding spot; thereby, an unsuitable point may be understood for measuring optimization with respect to the improvement of the system such as a guidance map being not easily illustrated or being not followed due to the slope or travel status of the surrounding vehicles.

It will be obvious to those skilled in the art that various changes may be made in the above-described embodiments of the present invention. However, the scope of the present invention should be determined by the following claims.

What is claimed:

1. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device; and
a control circuit configured to specify verification information used for verification of a defect cause from the vehicle state information stored in the temporary storage device based on the information specification reference stipulated in the stipulation table, and cause a predetermined storage media to store the specified verification information,
wherein the information specification reference in the stipulation table contains (i) a class of a parameter of the vehicular information storage apparatus and (ii) a class of verification information corresponding to the parameter and a range of the verification information,
the control circuit being further configured to,
when the parameter of the class stipulated in the stipulation table is changed,
specify the corresponding class of the verification information in the range stipulated in the stipulation table, and cause the predetermined storage media to store the verification information of the specified class and range.

2. The vehicular information storage apparatus according to claim 1, wherein
the stipulation table stipulates as a range to specify the verification information a predetermined time duration which includes a time when the parameter is changed.

3. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device; and
a control circuit configured to specify verification information used for verification of a defect cause from the'vehicle state information stored in the temporary storage device based on the information specification reference stipulated in the stipulation table, and cause a predetermined storage media to store the specified verification information,
wherein the information specification reference in the stipulation table contains an automatic start-up of a predetermined vehicular system and a class and a range of the verification information corresponding to the vehicular system,
the control circuit being further configured to,
when the automatic start-up of the predetermined vehicular system, which is stipulated in the stipulations table is executed,
specify the verification information of the corresponding class in the range stipulated in the stipulation table, and cause the predetermined storage media to store the verification information of the specified class and range.

4. The vehicular information storage apparatus according to claim 3, wherein
the stipulation table stipulates as a range to specify the verification information a predetermined time duration which includes a time when the automatic start-up of the predetermined vehicular system is executed.

5. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device; and
a control circuit configured to specify verification information used for verification of a defect cause from the vehicle state information stored in the temporary storage device based on the information specification reference stipulated in the stipulation table, and cause a predetermined storage media to store the specified verification information,
wherein the information specification reference in the stipulation table contains a predetermined set-up content and a class and a range of the verification information corresponding to the set-up content,
the control circuit being further configured to,
when the set-up content, which is stipulated in the stipulations table is executed,
specify the verification information of the corresponding class in the range stipulated in the stipulation table, and cause the predetermined storage media to store the verification information of the specified class and range.

6. The vehicular information storage apparatus according to claim 5, wherein
the stipulation table stipulates as a range to specify the verification information a predetermined time duration which includes a time when the predetermined set-up content is changed.

7. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device; and
a control circuit configured to specify verification information used for verification of a defect cause from the vehicle state information stored in the temporary storage device based on the information specification reference stipulated in the stipulation table, and cause a predetermined storage media to store the specified verification information,
wherein the information specification reference in the stipulation table contains a departure from a registration point and a class and a range of the verification information corresponding to the departure,
the control circuit being further configured to,
when the departure from the registration point, which is stipulated in the stipulation table, is executed,
specify the verification information of the corresponding class in the range stipulated in the stipulation table, and cause the predetermined storage media to store the verification information of the specified class and range.

8. The vehicular information storage apparatus according to claim 7, wherein
the stipulation table stipulates as a range to specify the verification information a predetermined time duration which includes a time when the departure from the registration point is made.

9. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of, a defect cause, out of the vehicle state information stored in the temporary storage device; and
a control circuit configured to specify verification information used for verification of a defect cause from the vehicle state information stored in the temporary storage device based on the information specification reference stipulated in the stipulation table, and cause a predetermined storage media to store the specified verification information,
wherein the information specification reference in the stipulation table contains an arrival to a destination and a class and a range of the verification information corresponding to the arrival,
the control circuit being further configured to,
when the arrival to the destination, which is stipulated in the stipulation table, is executed,
specify the verification information of the corresponding class in the range stipulated in the stipulation table, and cause the predetermined storage media to store the verification information of the specified class and range.

10. The vehicular information storage apparatus according to claim 9, wherein
the stipulation table stipulates as a range to specify the verification information a predetermined time duration which includes a time when the arrival to the destination is made.

11. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device; and
a control circuit configured to specify verification information used for verification of a defect cause from the vehicle state information stored in the temporary storage device based on the information specification reference stipulated in the stipulation table, and cause a predetermined storage media to store the specified verification information,
wherein the information specification reference in the stipulation table contains a defect detection by a user and a class and a range of the verification information corresponding to the defect detection,
the control circuit being further configured to,
when the defect detection by the user, which is stipulated in the stipulation table, is executed,
specify the verification information of the corresponding class in the range stipulated in the stipulation table, and cause the predetermined storage media to store the verification information of the specified class and range.

12. The vehicular information storage apparatus according to claim 11, wherein
the stipulation table stipulates as a range to specify the verification information a predetermined vicinity of a place where the defect detection is made by the user.

13. The vehicular information storage apparatus according to claim 11, wherein
the stipulation table stipulates, as a range to specify the verification information, verification information acquired under a same travel condition as a travel condition at a time when the defect detection is made by the user.

14. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device; and
a control circuit configured to specify verification information used for verification of a defect cause from the vehicle state information stored in the temporary storage device based on the information specification reference stipulated in the stipulation table, and cause a predetermined storage media to store the specified verification information,
wherein the information specification reference in the stipulation table contains a reception of an instruction command and a class and a range of the verification information corresponding to the reception of the instruction command,
the control circuit being further configured to,
when the reception of the instruction command, which is stipulated in the stipulation table, is executed,
specify the verification information of the corresponding class in the range stipulated in the stipulation table, and cause the predetermined storage media to store the verification information of the specified class and range.

15. The vehicular information storage apparatus according to claim 14, wherein
the stipulation table stipulates as a range to specify the verification information a predetermined time duration which starts from a time when the reception of the instruction command is made.

16. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
an input device configured to be used to input information indicating that a user recognizes a defect; and
a control circuit configured to
stipulate information specification reference to specify verification information, which is used for verification of a defect cause, based on the information inputted via the input device,
specify verification information used for verification of a defect cause out of the vehicle state information stored in the temporary storage device based on the stipulated information specification reference, and
cause a predetermined storage media to store the specified verification information,
the control circuit being further configured to,
when the verification information is not specified,
change the information specification reference and specify again verification information.

17. A vehicular information storage apparatus in a vehicle, the apparatus comprising:
a state information acquisition device configured to acquire vehicle state information of the vehicle;
a temporary storage device configured to store temporarily the vehicle state information acquired by the state information acquisition device;
a stipulation table storage device configured to store a stipulation table that stipulates an information specification reference for specifying verification information, which is used for verification of a defect cause, out of the vehicle state information stored in the temporary storage device;
a control circuit configured to specify verification information used for verification of a defect cause from the vehicle state information stored in the temporary storage device based on the information specification reference stipulated in the stipulation table, and cause a predetermined storage media to store the specified verification information; and
a communications area determination section configured to determine whether the vehicular information storage apparatus is inside or outside a communications area in which to communicate with an external information center,
the control circuit being further configured to specify verification information, which is used for verification of a defect cause, out of the vehicle state information stored in the temporary storage device, based on the information specification reference, which is differentiated according to a determination result of either being inside or outside the communications area by the communications area determination section.

18. The vehicular information storage apparatus according to claim 17, wherein
when it is determined that the apparatus is located outside the communications area, the control circuit is further configured to specify the verification information in a predetermined range, which is less than a predetermined range where the verification information is specified when it is determined that the apparatus is inside the communications area.

19. The vehicular information storage apparatus according to claim 17, wherein
when it is determined that the apparatus is located outside the communications area, the control circuit is further configured to thin out in specifying the verification information.

20. A vehicle diagnosis system for a vehicle, the system comprising:
at least one the vehicular information storage apparatus according to claim 1; and
an information center to communicate with the at least one vehicular information storage apparatus;
the at least one vehicular information storage apparatus comprising
a transmission device to transmit the specified verification information to the information center,
the information center comprising
(i) a reception device to receive the verification information transmitted from the at least one vehicular information storage apparatus,
(ii) an information storage device to store the verification information received by the reception device, and
(iii) an analysis section to analyze statistically the verification information stored in the information storage device.

21. A vehicle diagnosis system comprising:
at least one vehicular information storage apparatus according to claim 1; and
an information center to communicate with the at least one vehicular information storage apparatus,
the vehicular information storage apparatus comprising
(i) an advice guidance section to perform, at a predetermined time point, an advice guidance to provide advice about a driving manipulation of the vehicle,
(ii) a driving manipulation detection device to detect a driving manipulation of a user at a time point when the advice guidance is performed by the advice guidance section,
(iii) a driving manipulation determination section to determine whether the detected driving manipulation accords with the provided advice, and
(iv) a determination result report section to specify a position, where the driving manipulation not according with the provided advice is executed, when it is determined that the detected driving manipulation does not accord with the provided advice, and report to the information center the specified position as a discord determination result,
the information center comprising
(i) a determination result total section to total discord determination results received from the determination result report section of each of the at least one vehicular information storage apparatus with respect to each position,
(ii) a discord number determination section to determine whether there is a position where the totaled discord determination result is greater than a predetermined value by referring to the totaled discord determination result, and
(iii) an improvement position record section to record, when it is determined that there is the position where the discord determination results is greater than the predetermined value, as an improvement necessary position where a content of the advice needs to be amended.

22. A program product stored in a non-transitory computer-readable storage media, the program product comprising instructions causing a computer to function as the control circuit according to the vehicular information storage apparatus according to claim 1.
